(19) United States
(12) Patent Application Publication
(10) Pub. No.: US 2012/0253503 A1
(43) Pub. Date: Oct. 4, 2012

(54) CUTTING APPARATUS AND STORAGE MEDIUM STORING CUTTING CONTROL PROGRAM

(75) Inventors: Yoshinori Nakamura, Toyohashi-shi (JP); Yasuhiko Kawaguchi, Nagoya-shi (JP); Masahiko Nagai, Nagoya-shi (JP); Tomoyasu Niizeki, Ichinomiya-shi (JP); Katsuhisa Hasegawa, Kasugai-shi (JP)

(73) Assignee: BROTHER KOGYO KABUSHIKI KAISHA, Nagoya-shi (JP)

(21) Appl. No.: 13/424,015

(22) Filed: Mar. 19, 2012

(30) Foreign Application Priority Data
Mar. 30, 2011 (JP) 2011-075576

(51) Int. Cl. G05B 19/00

(52) U.S. Cl. 700/160

(57) ABSTRACT

A cutting apparatus includes a holding member selectable from a plurality of types of holding members according to respective types of objects to be cut, the holding member having an adhesive layer removably holding the object and set on the cutting apparatus while holding the object adherent to the adhesive layer, an identification medium located on the holding member for identifying the holding member type, an input unit inputting the object type into the control unit, a detection unit detecting the holding member type from the identification medium when the holding member has been set to the apparatus, and a determination unit determining whether or not the object type input from the input unit and the type of the holding member detected by the detection unit are consistent with each other. The control unit is configured to perform the control according to a result of determination by the determination unit.

### CROSS-REFERENCE TO RELATED APPLICATIONS

This application is based upon and claims the benefit of priority from the prior Japanese Patent Application No. 2011-075576 filed on Mar. 30, 2011, the entire contents of which are incorporated herein by reference.

### BACKGROUND

1. Technical Field

The present disclosure relates to a cutting apparatus in which a cutting blade and an object to be cut are moved relative to each other so that the object is cut by the cutting blade and a computer-readable storage medium storing a control program used to execute control to cut the object.

2. Related Art

There has conventionally been known a cutting plotter which automatically cuts a sheet-like object to be cut, such as paper or resin sheet. In the cutting plotter, the object is held vertically by rollers of a drive mechanism thereby to be moved in a first direction, and a carriage having a cutting blade is moved in a second direction perpendicular to the first direction, whereby the object is cut.

The aforementioned cutting plotter includes a type that operating conditions are settable according to a type of the object. The operating conditions include a moving speed of the cutting blade relative to the object and a pressing force of the cutting blade. More specifically, for example, a bar code indicative of a type of the object is affixed to the upper side of an object, and the carriage is provided with a sensor reading the bar code of the object set on the cutting plotter. The bar code is read by the sensor to detect the type of the object before the set object is cut, so that an operating condition is set according to the detected type.

Furthermore, for example, another Japanese Patent Application Publication JP-A-2005-205541 discloses a cutting plotter in which the object is affixed to a sheet-like member (corresponding to a holding member) having an adhesive layer formed by applying an adhesive agent to an upper side of the sheet-like member. The sheet-like member is moved in the first direction so that the object is cut.

In the former conventional cutting plotter, the type of the object is detected such that the cutting operation is executed under an operating condition according to the detected object type. Furthermore, it is suggested that the holding member provided in the above-described latter conventional cutting plotter be used with the formed cutting plotter. In this case, a type of the object is detected and the object can be cut under the operating condition according to the detected object type. However, when the adhesive layer of the holding member has an adhesion irrelevant to the detected object type, there is a possibility that the object may not reliably be held such that the object would be displaced from the holding member. Thus, the object cannot accurately be cut when the object is not reliably held by the holding member.

### SUMMARY

Therefore, an object of the disclosure is to provide a cutting apparatus in which the object can reliably be held by the holding member and can accurately be cut and a storage medium storing a control program for the cutting apparatus.

The present disclosure provides a cutting apparatus provided with a control unit which executes control to move a cutting blade and an object to be cut relative to each other thereby to cut the object by the cutting blade, the cutting apparatus comprising a holding member selectable from a plurality of types of holding members according to respective types of the objects, the holding member being provided with an adhesive layer which removably holds the object, the holding member being set on the cutting apparatus while holding the object corresponding thereto, which is adherent to the adhesive layer of the holding member; an identification medium which is provided on the holding member for identifying a type of the holding member; an input unit which is actuated for a user to input at least one of the type of the object and the type of the holding member into the control unit before the object is cut; a detection unit which detects the type of the holding member from the identification medium when the holding member has been set to the cutting apparatus; and a determination unit which determines whether or not the type of the object input from the input unit and the type of the holding member detected by the detection unit are consistent with each other and/or whether or not the type of the holding member detected by the detection unit and the type of the holding member input from the input unit are consistent with each other, wherein the control unit is configured to perform the control according to a result of determination by the determination unit.

### BRIEF DESCRIPTION OF THE DRAWINGS

In the accompanying drawings:

FIG. 1 is a perspective view of the cutting apparatus according to a first embodiment, showing an inner structure thereof;

FIG. 2 is a plan view of the cutting apparatus;

FIG. 3 is a perspective view of a cutter holder;

FIG. 4 is a front view of the cutter holder, showing the state where a cutter has been descended;

FIG. 5 is a sectional view of the cutter holder, showing the case where the cuter has been ascended;

FIG. 6 is a sectional view taken along lines VI-VI in FIG. 4;

FIG. 7 is an enlarged front view of a gear;

FIG. 8 is an enlarged view of the vicinity of a distal end of the cutter during the cutting;

FIG. 9 is a side view of the vicinity of a cutter holder during the cutting;

FIG. 10 is a block diagram showing an electrical arrangement of the cutting apparatus;

FIGS. 11A and 11B illustrate a plurality of types of holding members and an identification medium;

FIGS. 12A and 12B show a type selecting program for the holding member and a switch table corresponding to the types of the holding member, respectively;

FIGS. 13A and 13B show setting screens in the case where the types of paper and cloth both serving as the object; and

FIG. 14 is a flowchart showing the flow of processing of determining the holding member.

### DETAILED DESCRIPTION

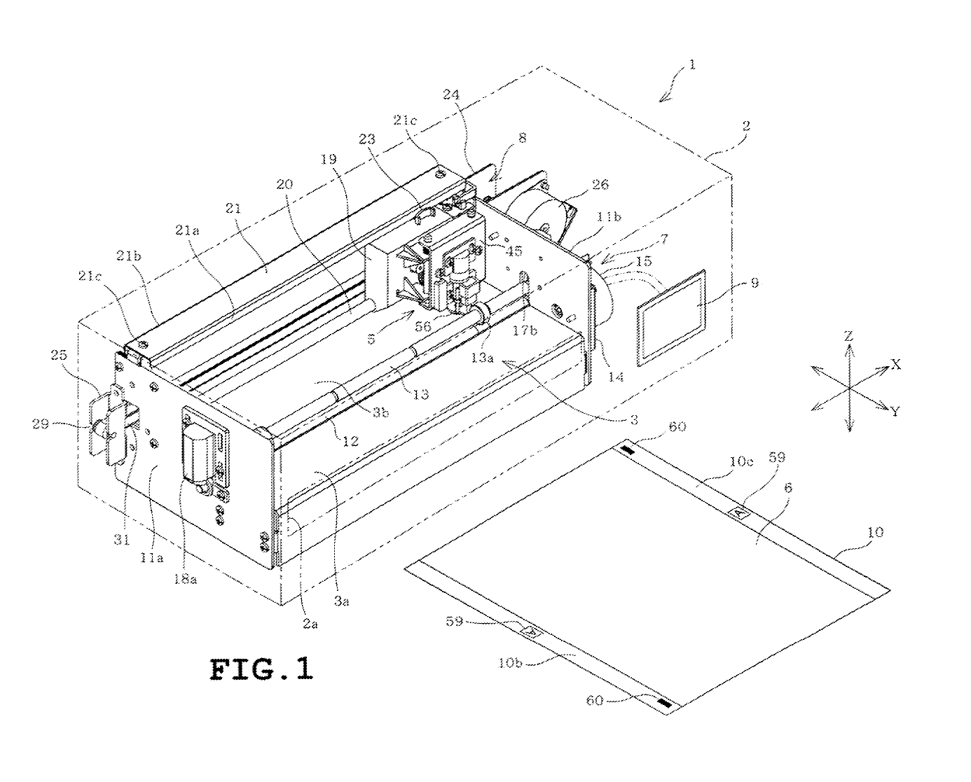

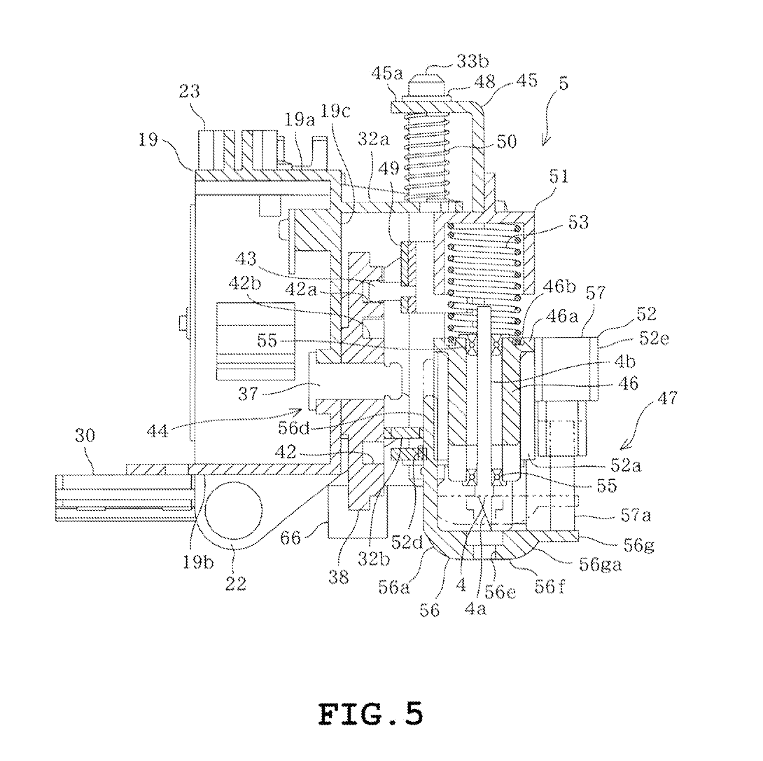

One embodiment will be described with reference to FIGS. 1 to 14. Referring to FIG. 1, a cutting apparatus 1 includes a body cover 2 as a housing, a platen 3 provided in the body cover 2 and a cutter holder 5. The cutting apparatus 1 also includes first and second moving units 7 and 8 for moving a cutter 4 (see FIG. 5) of the cutter holder 5 and an object 6 to be cut relative to each other. The body cover 2 is formed into the shape of a horizontally long rectangular box and has a front formed with a horizontally long opening 2a which is provided for setting a holding sheet 10 holding the object 6. In the following description, the side where the user who operates the cutting apparatus 1 stands will be referred to as “front” and the opposite side will be referred to as “back.” The front-back direction thereof will be referred to as “Y direction.” The right-left direction perpendicular to the Y direction will be referred to as “X direction.”

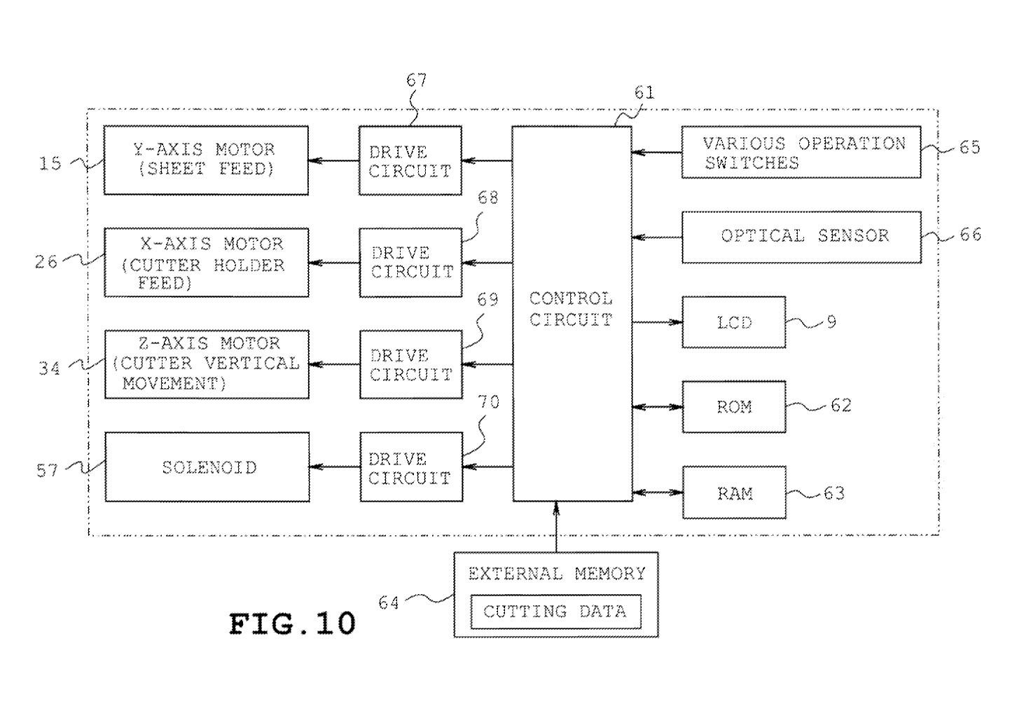

On a right part of the body cover 2 is provided a liquid crystal display (LCD) 9 which serves as a display unit displaying messages and the like necessary for the user. A plurality of operation switches 65 (see FIG. 10) is also provided on the right part of the body cover 2. The platen 3 includes a pair of front and rear plate members 3a and 3b and has an upper surface which is configured into an XY plane serving as a horizontal plane. The platen 3 is set so that a holding sheet 10 holding the object 6 is placed thereon. The holding sheet 10 is received by the platen 3 when the object 6 is cut. The holding sheet 6 has an upper surface with an adhesive layer (see FIG. 8) 10a formed by applying an adhesive agent to a part thereof except for a left edge 10b, a right edge 10c and a rear edge 10 and a front edge thereof. The object 6 is attached to the adhesive layer 10a of the holding sheet 10.

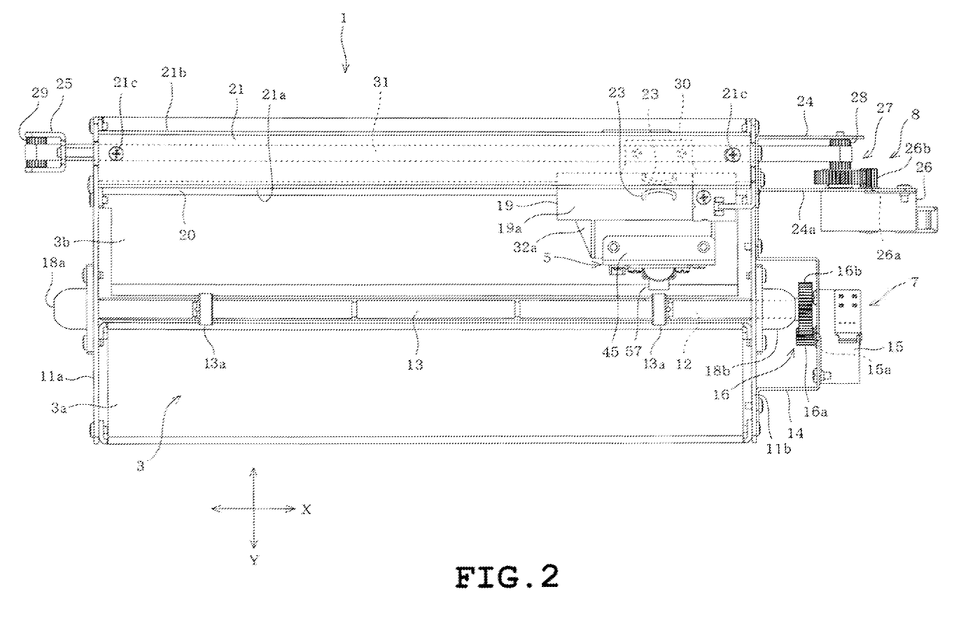

The first moving unit 7 moves the holding sheet 10 on the upper surface side of the platen 3 in the Y direction (a first direction). More specifically, a driving roller 12 and a pinch roller 13 are provided on right and left sidewalls 11b and 11a so as to be located between plate members 3a and 3b. The driving roller 12 and the pinch roller 13 extend in the X direction and are rotatably supported on the sidewalls 11b and 11a. The driving roller 12 and the pinch roller 13 are disposed so as to be parallel to the X-Y plane and so as to be vertically arranged. The driving roller 12 is located lower than the pinch roller 13. A first crank-shaped mounting frame 14 is provided on the right sidewall 11b so as to be located on the right of the driving roller 12 as shown in FIG. 2. A Y-axis motor 15 is fixed to an outer surface of the mounting frame 14. The Y-axis motor 15 comprises a stepping motor, for example and has a rotating shaft 15a extending through the first mounting frame 14 and further has a distal end provided with a gear 16a. The driving roller 12 has a right end to which is secured another gear 16b which is brought into mesh engagement with the gear 16a. These gears 16a and 16b constitute a first reduction gear mechanism 16. The pinch roller 13 is guided by guide grooves 17b formed in the right and left sidewalls 11b and 11a so as to be movable upward and downward. Only the right guide groove 17b is shown in FIG. 1. Two spring accommodating members 18a and 18b are mounted on the right and left sidewalls 11b and 11a in order to cover the guide groove 17b from the outside respectively. The pinch roller 13 is biased downward by compression coil springs (not shown) accommodated in the spring accommodating portions 18a and 18b respectively. The pinch roller 13 is provided with pressing portions 13a which are brought into contact with a left edge 10b and a right edge 10c of the holding sheet 10, thereby pressing the edges 10b and 10c, respectively. Each pressing portion 13a has a slightly larger outer diameter than the other portion of the pinch roller 13.

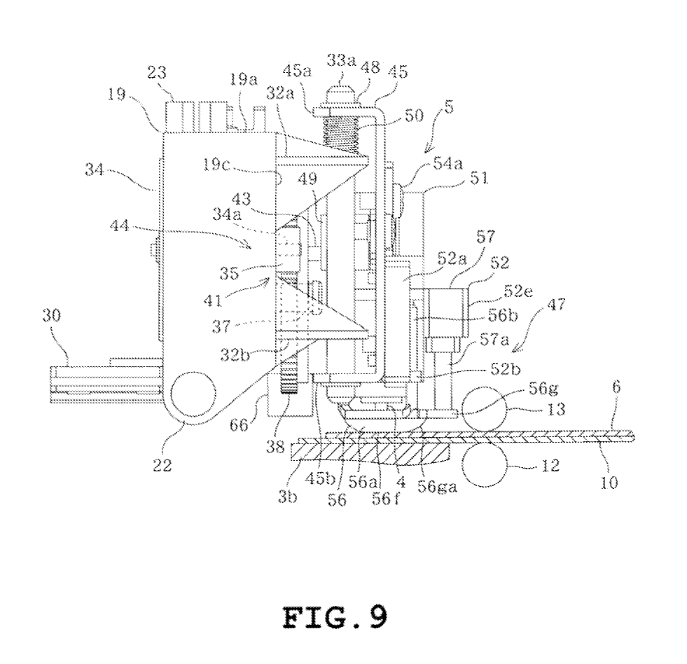

The driving roller 12 and the pinch roller 13 press the holding sheet 10 from below and from above by the urging force of the compression coil springs thereby to hold the holding sheet 10 therebetween (see FIG. 9). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism 16, the compression coil springs and the like.

The second moving unit 8 moves a carriage 19 supporting the cutter holder 5 in the X direction (a second direction). The second moving unit 8 will be described in more detail. A guide shaft 20 and a guide frame 21 both extending in the right-left direction are provided between the right and left sidewalls 11b and 11a so as to be located at the rear end of the cutting apparatus 1, as shown in FIGS. 1 and 2. The guide shaft 20 is disposed in parallel with the driving roller 12 and the pinch roller 13. The guide shaft 20 located right above the platen 3 extends through a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting apparatus 1, and an auxiliary frame 25 is mounted on the left sidewall 11a in the rear of the cutting apparatus 1, as shown in FIG. 2. An X-axis motor 26 and a second reduction gear mechanism 27 are provided on the second mounting frame 24. The X-axis motor 26 comprises a stepping motor, for example and is fixed to a front of a front mounting piece 24a. The X-axis motor 26 includes a rotating shaft 26a which extends through the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 connected to a rear end (a mounting portion 30 as will be described later) of the carriage 19 extends between the pulleys 28 and 29.

Upon drive of the X-axis motor 26, normal or reverse rotation of the X-axis motor 26 is transmitted via the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction perpendicular to the Y direction in which the object 6 is conveyed. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

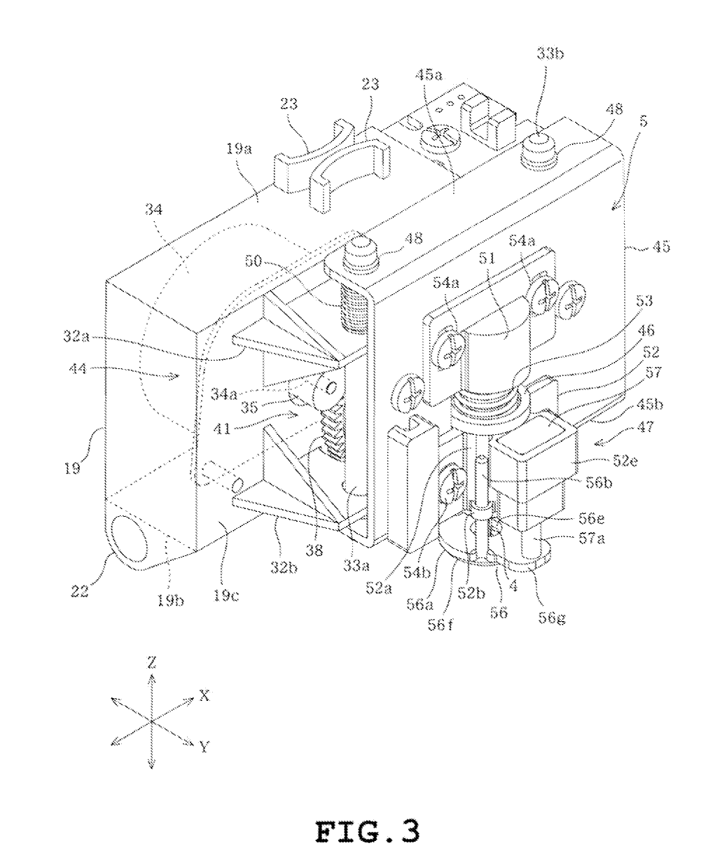

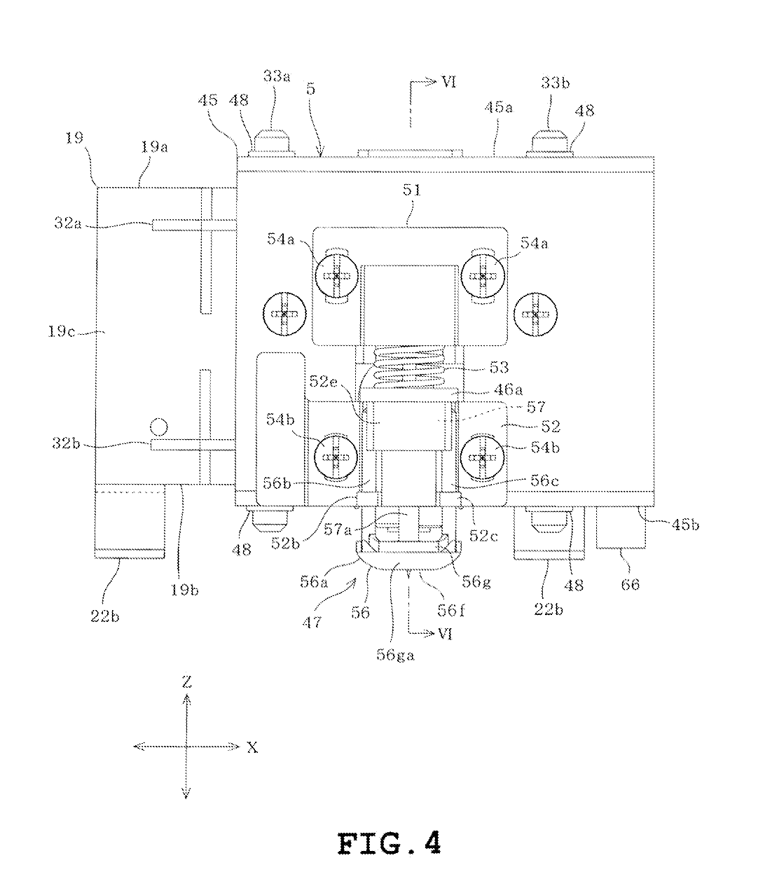

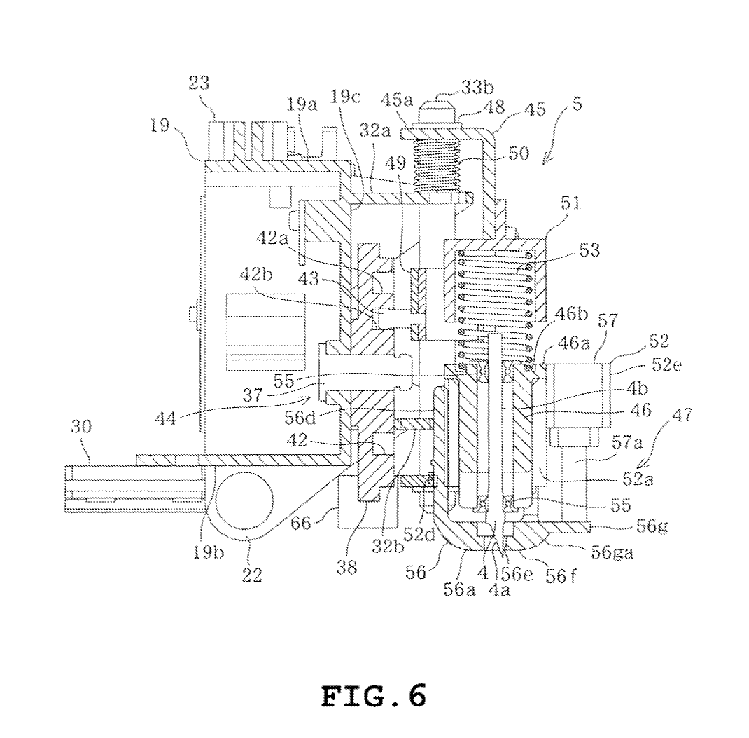

The cutter holder 5 is disposed on the front of the carriage 19 and is supported so as to be movable in a vertical direction (a third direction) serving as a Z direction. The carriage 19 and the cutter holder 5 will be described with reference to FIGS. 3 to 9 as well as FIGS. 1 and 2. The carriage 19 is formed into the shape of a substantially rectangular box with an open rear as shown in FIGS. 2 and 3. The carriage 19 has an upper wall 19a with which a pair of upwardly protruding front and rear guided members 23 are integrally formed. The guided members 23 are arc-shaped ribs as viewed in a planar view. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted, as shown in FIGS. 4, 5 and 6. An attaching portion 30 (see FIGS. 5 and 6) is mounted on the bottom wall 19b of the carriage 19 so as to protrude rearward. The attaching portion 30 is to be coupled with the timing belt 31. The carriage 19 is thus supported by the guide shaft 20 inserted through the holes 22 so as to be slidable in the right-left direction and further supported by the guide frame 21 held between the guided members 23 so as to be prevented from being rotated about the guide shaft 20.

The carriage 19 has a front wall 19c with which a pair of upper and lower support portions 32a and 32b are formed so as to extend forward as shown in FIGS. 3 to 5, 9, etc. A pair of right and left support shafts 33b and 33a extending through the respective support portions 32a and 32b are mounted on the carriage 19 so as to be vertically movable. A Z-axis motor 34 comprising, for example, a stepping motor is accommodated in the carriage 19 backward thereby to be housed therein. The Z-axis motor 34 has a rotating shaft 39a (see FIGS. 3 and 9) which extends through the front wall 19c of the carriage 19. The rotating shaft 34a has a distal end provided with a gear 35. Furthermore, the carriage 19 is provided with a gear shaft 37 which extends through a slightly lower part of the gear 35 relative to the central part of the front wall 19c as shown in FIGS. 5, 6 and 9. A gear 38 which is brought into mesh engagement with the gear 35 in front of the front wall 19c is rotatably mounted on the gear shaft 37. The gear 38 is retained by a retaining ring (not shown) mounted on a front end of the gear shaft 37. The gears 35 and 38 constitute a third reduction mechanism 41 (see FIGS. 3 and 9).

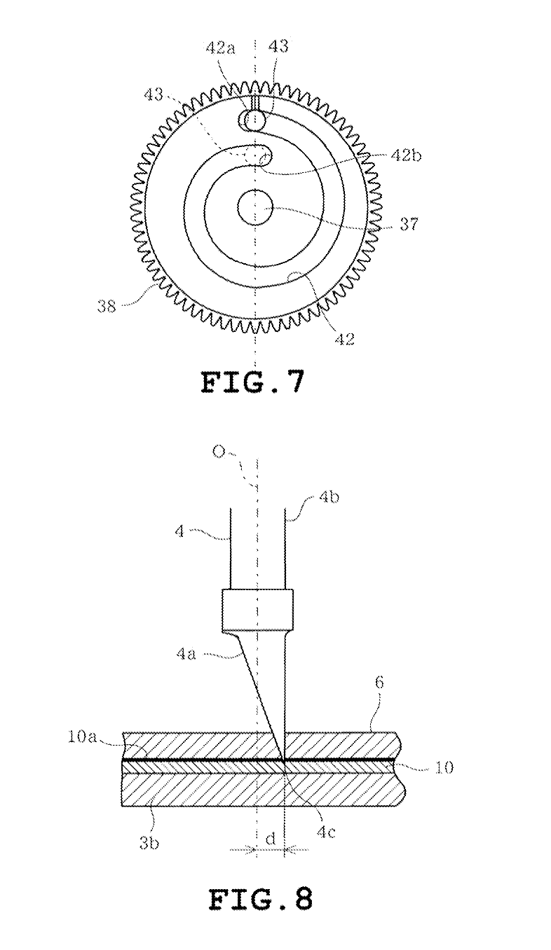

The gear 38 is formed with a spiral groove 42 as shown in FIG. 7. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder 5 engages the spiral groove 42 (see FIGS. 5 and 6) as will be described in detail later. Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cutter holder 5 is moved upward or downward together with the support shafts 33a and 33b. In this case, the cutter holder 5 is moved between a raised position (see FIGS. 5 and 7) where the engagement pin 43 is located at the first end 42a of the spiral groove 42 and a lowered position (see FIGS. 6 and 7) where the engagement pin 43 is located at the second end 42b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 provided on the support shafts 33a and 33b, a movable cylindrical portion 46 which has a cutter 4 (a cutting blade) and is held by the holder body 45 so as to be vertically movable and a pressing device 47 which presses the object 6. More specifically, the holder body 45 has an upper end 45a and a lower end 45b both of which are folded rearward such that the holder body 45 is generally formed into a C-shape, as shown in FIGS. 3 to 5, 9 and the like. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a rearwardly directed engagement pin 43 as shown in FIGS. 5 and 6. The holder body 45, support shafts 33a and 33b, the engagement pin 43 and the coupling member 40 are formed integrally with one another as shown in FIGS. 5 and 6. The cutter holder 5 is vertically moved by the third moving unit 44 in conjunction with the engagement pin 43. Furthermore, compression coil springs 50 serving as biasing members are mounted about the support shafts 33a and 33b so as to be located between upper surfaces of the support portion and upper end of the holder boy 45, respectively. The entire cutter holder 5 is elastically biased upward by biasing force of the compression coil springs 50.

An optical sensor 66 is mounted on a right part of the underside of the lower end 45b of the holder body 45 as shown in FIG. 4. The optical sensor 66 will be described in detail later. The optical sensor 66 is formed integrally with the holder body 45 to detect a type of the holding sheet 10.

Mounting members 51 and 52 provided for mounting the movable cylindrical portion 46, the pressing device 47 and the like are fixed to the middle portion of the holder body 45 by screws 54a and 54b respectively, as shown in FIGS. 3 and 4. The lower mounting member 52 is provided with a cylindrical portion 52a (see FIG. 5) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end on which a flange 46a supported on an upper end of the cylindrical portion 52a is formed so as to expand radially outward. A spring shoe 46b is provided on an upper end of the flange 46a. A compression coil spring 53 is interposed between the upper mounting member 51 and the spring shoe 46b of the movable cylindrical portion 46 as shown in FIGS. 5 and 6. The compression coil spring 53 biases the movable cylindrical portion 46 (the cutter 4) to the lower object 6 side while allowing the upward movement of the movable cylindrical portion 46 against the biasing force when an upward force acts on the cutter 4.

The cutter 4 is provided in the movable cylindrical portion 46 so as to extend therethrough in the axial direction. In more detail, the cutter 4 has a round bar-like cutter shaft 4b which is longer than the movable cylindrical portion 46 and a blade 4a integrally formed on a lower end of the cutter shaft 4b. The blade 4a is formed into a substantially triangular shape and has a lowermost blade edge 4c formed at a location offset by a distance d from a central axis O of the cutter shaft 4b, as shown in FIG. 8. The cutter 4 is held by bearings 55 (see FIG. 5) mounted on upper and lower ends of the movable cylindrical portion 46 so as to be rotatably movable about the central axis O (the Z axis) in the vertical direction. Thus, the blade edge 4c of the cutter 4 presses an X-Y plane or the surface of the object 6 from the Z direction perpendicular to the X-Y plane. Furthermore, the cutter 4 has a height that is set so that when the cutter holder 5 has been moved to a lowered position, the blade edge 4c passes through the object 6 on the holding sheet 10 but does not reach the upper surface of the plate member 3b of the platen 3, as shown in FIG. 8. On the other hand, the blade edge 4c of the cutter 4 is moved upward with movement of the cutter holder 5 to the raised position, thereby being departed from the object 6 (see FIG. 5).

Three guide holes 52b, 52c and 52d (see FIGS. 3 to 5 and 9) are formed at regular intervals in a circumferential edge of the lower end of the cylindrical portion 52a. A pressing member 56 is disposed under the cylindrical portion 52a and has three guide bars 56b, 56c and 56d which are to be inserted into the guide holes 52b to 52d respectively. The pressing member 56 includes a lower part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56e which vertically extends to cause the blade 4a to protrude therethrough. The pressing portion body 56a has an underside serving as a contact 56f which is brought into contact with the object 6 while the blade 4a is located in the hole 56e. The contact 56f is formed into an annular horizontal flat surface and is brought into surface contact with the object 6. The contact 56f is made of a fluorine resin such as Teflon® so as to have a lower coefficient of friction, whereupon the contact 56f is rendered slippery relative to the object 6.

The pressing portion body 56a has a guide 56g which is formed integrally on the circumferential edge thereof so as to extend forward, as shown in FIGS. 3 to 5 and 9. The guide 56g is located in front of and above the contact 56f and includes an inclined surface 56ga inclined rearwardly downward to the contact 56f side. Consequently, when the holding sheet 10 holding the object 6 is moved rearward relative to the cutter holder 5, the object 6 is guided downward by the guide 56g so as not to be caught by the contact 56f.

The mounting member 52 has a front mounting portion 52e for the solenoid 57, integrally formed therewith. The front mounting portion 52e is located in front of the cylindrical portion 52a and above the guide 56g. The solenoid 57 serves as an actuator for vertically moving the pressing member 56 thereby to press the object 6 and constitutes a pressing device 47 (a pressing unit) together with the pressing member 56 and a control circuit 61 which will be described later. The solenoid 57 is mounted on the front mounting portion 52e so as to be directed downward. The solenoid 57 includes a plunger 57a having a distal end fixed to the upper surface of the guide 56g. When the solenoid 57 is driven with the cutter holder 5 occupying the lowered position, the pressing member 56 is moved downward together with the plunger 57a thereby to press the object 6 at a predetermined pressure (see FIG. 9). On the other hand, when the plunger 57a is located above during non-drive of the solenoid 57, the pressing member releases the object 6 from application of the pressing force. When the cutter holder 5 is moved to the raised position during non-drive of the solenoid 57 (see two-dot chain line in FIG. 5), the pressing member 56 is completely departed from the object 6.

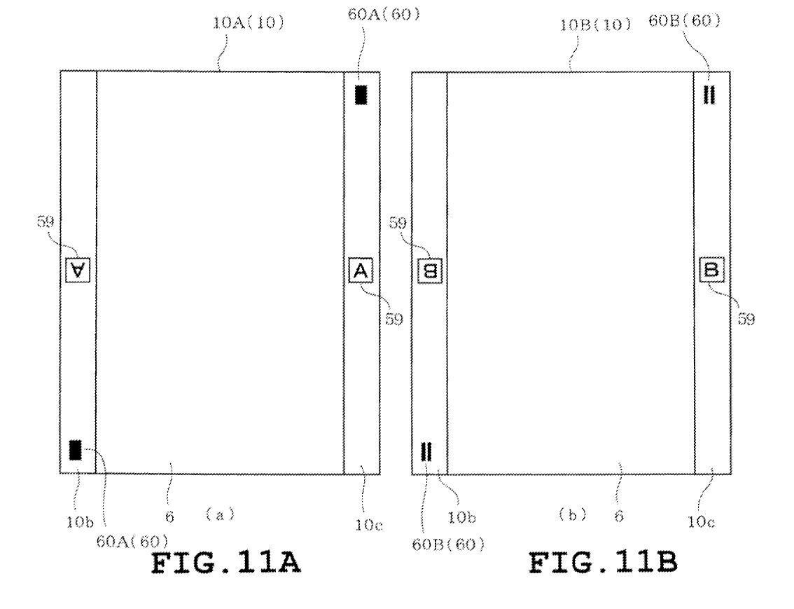

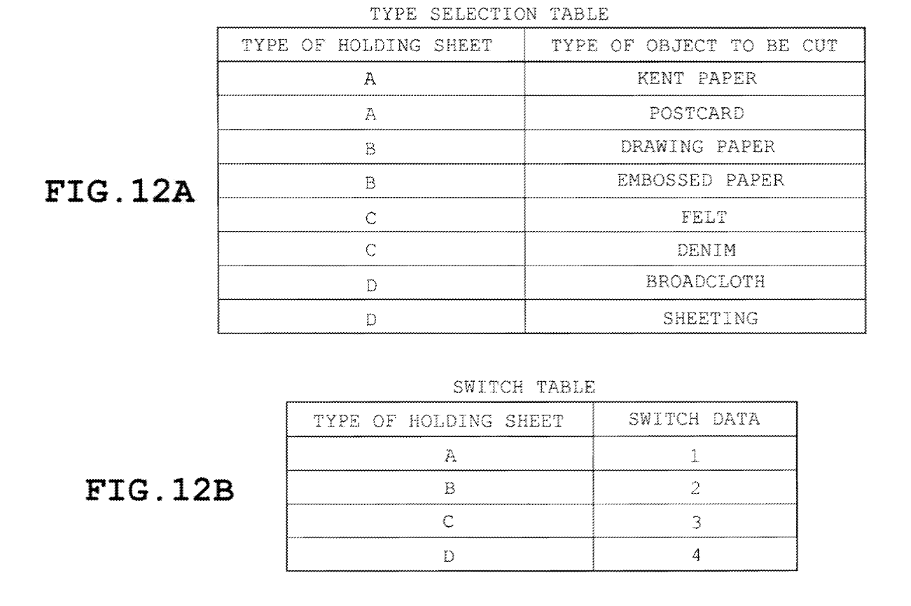

A plurality of types of holding sheets 10 is prepared according to types of objects 6. An identification mark 60 is attached to each holding sheet 10 to identify the type of the holding sheet 10. Furthermore, a mark 59 is given to each holding sheet 10 in order that the user may discriminate the type of object 6 when viewing the mark 59. The holding sheet 10, the identification mark 60 and the mark 59 will be described with reference to FIGS. 11A to 12A. The holding sheet 10 is made of, for example, a synthetic resin and formed into a flat rectangular plate shape, as shown in FIGS. 1, 11A and 11B. The holding sheet 10 is placed opposite the cutter 4 and has a side (a top face) on which an adhesive layer 10a (see FIG. 8) is formed by applying an adhesive agent to the holding sheet 10 except for a peripheral edge including a left edge 10b and a right edge 10c.

The corresponding type of object 6 is attached to the adhesive layer of the holding sheet 10, whereby the object 6 is removably held by the holding sheet 10. The adhesive layer 10a has such an adhesion that the object 6 is immovably held while the object 6 is being cut by the cutter 4. More specifically, when paper such as Kent paper or postcard as the object 6 is to be cut, a holding paper 10A with adhesion suitable for immovably holding the paper is selected, as exemplified in FIGS. 11A and 12A. Furthermore, when drawing paper or embossed paper is to be cut, a holding paper 10B with adhesion suitable for immovably holding the paper is selected, as exemplified in FIGS. 11B and 12A. More specifically, drawing paper and embossed paper differ from Kent paper and postcard in a paper quality such as a degree of surface irregularity (smoothness), unpliableness (stiffness) or the like. Accordingly, the adhesive layer 10a has an adhesion set according to characteristics of each object 6 and also set so that the object 6 can be prevented from being broken when the object 6 is removed from the adhesive layer 10a.

Furthermore, when a cloth is used as the object 6, a holding sheet 10C is prepared which is set to an adhesion suitable to immovably hold felt or denim, although not shown. A holding sheet 10D is prepared which is set to an adhesion suitable to immovably hold broadcloth or sheeting. Thus, a plurality of types of holding sheets 10 is prepared (see FIG. 12A). More specifically, since felt and denim differs from broadcloth or sheeting in the cloth quality such as cloth thickness or elastic property, the adhesive layer 10a has an adhesion set according to a cloth quality of each object 6. The aforementioned plural (for example, four) types of holding sheets 10A to 10D have an adhesion relationship shown as 10A<10B<10C<10D. Thus, the adhesion of the adhesive layer 10a is set to the aforementioned four values according to the types A to D of the objects 6 respectively. It is of course needless to say that the types of the holding sheets 10A to 10D should not be limited to the above-described four types.

The identification mark 59 (corresponding to an identification medium) differs according to the holding sheets 10A to 10D. FIGS. 11A and 11B show examples of identification marks 60A and 60B provided on the holding sheets 10A and 10B, respectively. The identification mark 60 is a mark printed on the holding sheets 10A and 10B in the form of a barcode. The identification mark 60A is composed of a single black line (bar) as shown in FIG. 11A, whereas the identification mark 60B is composed of two black lines (bars) as shown in FIG. 11B. Furthermore, the identification mark 60C is composed of three black lines (bars) and the identification mark 60D is composed of four black lines (bars), although both black lines are not shown. Two identification marks 60A as shown in FIG. 11A correspond to type A and are provided on a front side (or lower) left end 10b of the upper surface and on an inner side right end 10c of the holding sheet 10A respectively. The identification marks 60A are provided on the positions to be detected by the optical sensor 66 even when the holding sheet 10A is set in a predetermined direction (see FIG. 1) or in a 180-degree opposite direction. More specifically, the identification marks 60A are symmetrical about a central point (an intersection of two diagonal lines of the holding sheet 10A) of the holding sheet 10A. Regarding the other holding sheets 10B to 10D, too, identification marks 60 corresponding to types B to D are printed on the same positions as the holding sheet 10A (see identification mark 60B in FIG. 11B).

The mark 59 will now be described. The mark 59 is provided for the user to discriminate the type of the holding sheet 10 by viewing the mark 59. Two marks 59 are affixed to generally middle positions of the left and right ends 10b and 10c of the holding sheet 10 respectively as shown in each of FIGS. 11A and 11B. Characters “A” and “B” serving as the marks 59 are printed on the holding sheets 10A and 10B respectively. Furthermore, as described above, the characters printed on the left ends 10b are upside down since the holding sheet 10 can be set to the cutting apparatus 10 in an upside down orientation relative to that shown in FIGS. 11A and 11B. Furthermore, corresponding characters are also printed on the holding sheets 10C and 10D in the same manner as described above, respectively, although not shown. The mark 59 may be a numeral, sign, pattern, figure, landmark, etc., instead of character. Furthermore, the location of the mark 59 should not be limited to those shown in FIGS. 11A and 11B, and the number of the marks 59 should not be limited to two. The identification mark 60 may be configured to be co-used as the mark 59. Still furthermore, different colors are given to the holding sheets 10 according to the sheet types. In this case, an entire holding sheet 10 may be colored or a part of the holding sheet 10 may be colored. Of course, both mark and color may be applied to each holding sheet 10.

An electrical arrangement of the control system for the cutting device 1 will be described with reference to the block diagram shown in FIG. 10. A control circuit (a control unit) 61 controlling the entire cutting apparatus 1 mainly comprises a computer (CPU). A ROM 62, a RAM 63 and an external memory 64 each serving as a storage unit are connected to the control circuit 61. The ROM 62 stores a cutting control program for controlling the cutting operation, a switch table, a type selection table regarding the holding sheets 10A to 10D, and the like. The external memory 64 stores data of a plurality of types of cutting data. The RAM 63 is provided with storage areas for temporarily storing various data and programs necessary for various processes.

To the control circuit 61 are connected drive circuits 67, 68, 69 and 70 driving the Y-axis motor 15, the X-axis motor 26, the Z-axis motor 34 and the solenoid 57 respectively. Upon execution of the cutting control program, the control circuit 61 controls the Y-axis motor 15, the X-axis motor 26, the Z-axis motor 34 and the solenoid 57 based on the above-described cutting data, whereby the cutting operation is automatically executed for the object 6 on the holding sheet 10.

Furthermore, to the control circuit 61 are connected the aforementioned various switches 65 which will hereinafter be referred to as “operation switches 65”), the optical sensor 66 and the LCD 9. The optical sensor 66 is a reflection sensor and includes a light-emitting section which emits light and a light-receiving section which receives light. The light-emitting section emits light to the identification mark 60 when the holding sheet 10 is set on the cutting apparatus 1. On the other hand, the light-receiving section receives the light reflected on the identification mark 60 on the holding sheet 10. The aforementioned identification mark 60 is a barcode, and the number of bars can be detected on the basis of the intensity of the reflected light. More specifically, a detection signal is supplied on the basis of an amount of light received by the light-receiving section. The control circuit 61 determines the number of bars, based on the detection signal. The control circuit 61 then specifies one of the types A to D of the holding sheets 10A to 10D from the result of detection (switch data; and see FIG. 12B), while referring to the switch table. The control circuit 61 and the optical sensor 66 thus constitute a detection unit which detects the type of the holding sheet 10 from the identification mark 60. FIG. 12B exemplifies the switch table stored in the ROM 62. As shown, the switch table stores four switch data determined from the detection signal supplied from the optical sensor 66.

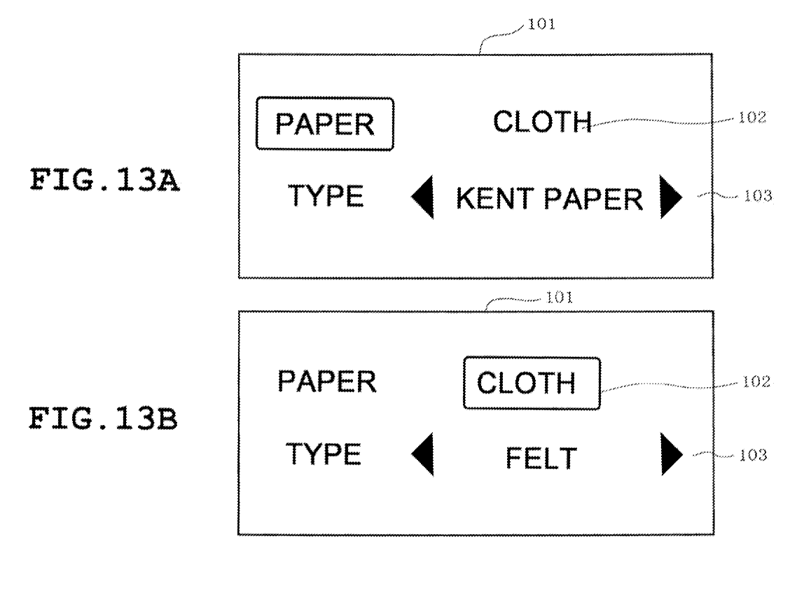

While viewing the contents displayed on the LCD 9, the user operates one or more of the operation switches 65 thereby to carry out an input operation to select the cutting data of a desired contour and input to select the type of the object 6. FIGS. 13A and 13B exemplify screens for setting the type of the object 6 on the LCD 9. More specifically, a type setting screen 101 is provided with a large classification setting area 102 of the object 6 type on an upper part thereof and a small classification setting area 103 of the object 6 type on a lower part thereof, as shown in FIG. 13A. The user operates the operation switches 65 to select one of the paper types or one of cloth types displayed on the large classification setting area 102. Types belonging to the selected classification are then displayed on the small classification setting area 103. More specifically, “Paper” is selected on the large classification setting area 102 in FIG. 13A (see thick-frame part in FIG. 13A). One of “Kent paper,” “Postcard,” “Drawing paper” and “Embossed paper” is selectively displayed on the small classification setting area 103, whereby a desired paper type is entered. “Cloth” is selected on the large classification setting area 102 in FIG. 13B (see thick-frame part in FIG. 13B). One of “Felt,” “Denim,” “Broadcloth” and “Sheeting” is selectively displayed, whereby a desired cloth type is entered.

The ROM 62 stores a type selection table in which “Kent paper,” “Postcard,” “Denim,” “Broadcloth” and “Sheeting” are associated with types A to D of the holding sheets 10A to 10D, as shown in FIG. 12A. The control circuit 61 specifies one of types A to D of the holding sheets 10A to 10D corresponding to the paper type or cloth type entered by the user, while referring to the type selection table. The aforementioned operation switches 65 and the LCD 9 constitute an input unit the user operates to enter data of the type of the object 6 into the control circuit 61.

A touch panel having a plurality of touch keys comprising transparent electrodes may be provided on the front surface of the LCD 9 so that data of the type of the object 6 is entered on the basis of input operation of the touch keys. Furthermore, the user may enter the types A to D of the holding sheets 10A to 10D, instead of the type of the object 6, as will be described in detail later.

The control circuit 61 functions as a determining unit which determines whether or not the type of the object 6 or one of the types A to D of the holding sheets 10A to 10D entered by the input unit are consistent with one of the types of the holding sheets 10A to 10D detected by the optical sensor 66. Furthermore, the LCD 9 serves as an informing unit which informs the user of the result of determination by the determining unit on the display screen before start of the cutting.

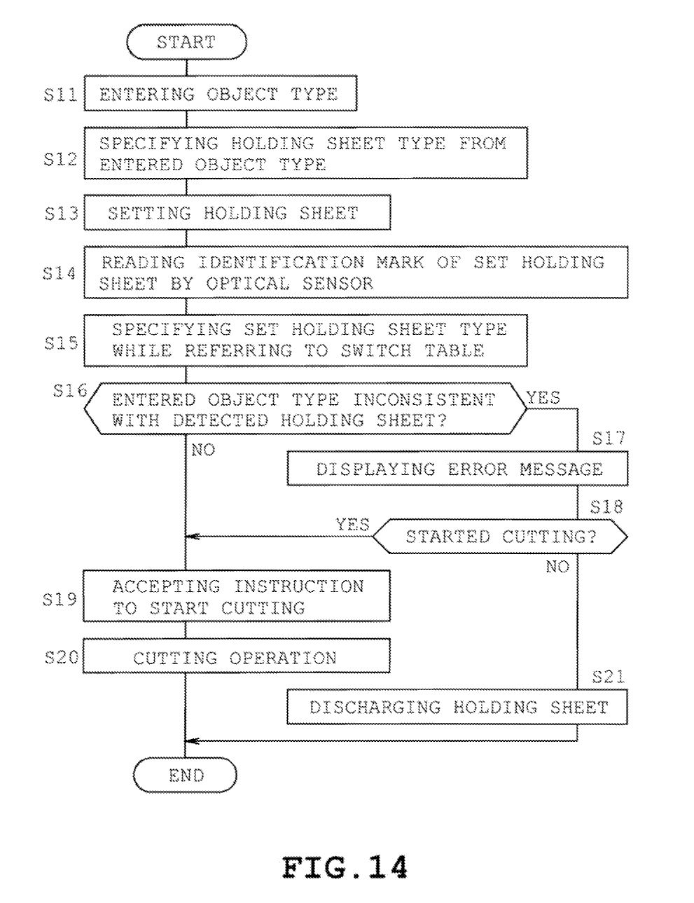

A concrete processing procedure by the cutting apparatus 1 at the time of start of the cutting will now be described with reference to FIG. 14 as well as FIGS. 1 to 13B. The flowchart of FIG. 14 shows a processing flow of the program executed by the control circuit 61. In the figure, a symbol Si (where i=11, 12, 13 and . . . ) designates each step.

The user prepares the object 6 to be cut and the holding sheet 10 corresponding to the type of the object 6 and affixes the object 6 to the adhesive layer 10a of the holding sheet 10. The user then operates the operation switches 65 to select a desired cutting data from the cutting data stored in the external memory 64. The user then operates the operation switches 65 to select a desired contour data from the contour data stored in the external memory 64 and to enter the type of the set object 6 (step S11). For example, when the holding sheet 10A for Kent paper is used, “Kent paper” is displayed on a type setting screen 101 (see FIG. 13A) of the LCD 9, whereby the type is entered. The control circuit 61 refers to the type selection table as shown in FIG. 12A to specify the type A of the holding sheet 10A corresponding to “Kent paper” (step S12).

On the other hand, the cutter holder 5 occupies the raised position before start of the cutting of the object 6 in the cutting apparatus 1 (see FIG. 5). In this state, the user sets the holding sheet 10 holding the object 6 through the opening 2a of the cutting apparatus 1 (step S13). The control circuit 61 reads the identification mark 60 of the set holding sheet 10 by the optical sensor 66 (step S14). In this case, the identification marks 60 are printed on positions symmetrical with respect to the center of the holding sheet 10. Accordingly, the optical sensor 66 can read the identification mark 60 when the holding sheet 10 set at step S13 is placed with a predetermined orientation or even when the holding sheet 10 is 180-degree reversed with respect to the predetermined orientation.

Subsequently, the control circuit 61 refers to the switch table stored in the ROM 62 to specify one of the types A to D from the switch data that is based on the detection signal from the optical sensor 66 (step S15). The control circuit 61 then determines whether or not the type of the object 6 based on the user input at step S11 is inconsistent with one of the types A to D of the holding sheet 10 detected by the optical sensor 66 at step S14 (step S16). When determining at step S16 that the type of the object 6 is inconsistent with one of the types A to D of the holding sheet 10 (YES at step S16), the control circuit 61 displays an error message (an informing screen not shown) on the LCD 9, informing error of the user (step S17). Furthermore, the control circuit 61 also simultaneously displays on the LCD 9 a message as to whether or not the cutting of the object 6 on the holding sheet 10 is started. When the user operates the operation switches 65, determining that the cutting should be started, the control circuit 61 accepts the signal or the instruction to start the cutting (YES at step S18; and step S19), starting the cutting operation (step S20). On the other hand, when no instruction to start the cutting has been entered by the user (NO at step S18), the control circuit 61 feeds the holding sheet 10 to the front side to discharge it (step S21), ending the processing.

When determining at step S16 that the type of the object 6 is consistent with one of the types A to D of the holding sheet 10 (NO at step S16), the control circuit 61 accepts the user's instruction to start the cutting, starting the cutting operation (steps S19 and S20). In the cutting operation, the Y-axis and X-axis motors 15 and 26 are firstly driven in order that the blade edge 4c of the cutter 4 may be moved to the cutting start point, whereby the cutter 4 and the object 6 are moved relative to each other. When the cutter 4 has been moved to the cutting start point, the solenoid 57 is driven so that the object 6 is pressed by the pressing member 56. Furthermore, the Z-axis motor 34 is driven to the lowered position so that the blade edge 4c of the cutter 4 passes through the cutting start point of the object 6. The Y-axis and X-axis motors 15 and 26 are then driven on the basis of the cutting data to move the cutter 4 and the object 6 relative to each other so that the object 6 is cut.

With the relative movement of the cutter 4 during the cutting, the cutter 4 is subjected to a resistance force of the object 6. In this case, an optimum holding sheet 10 is used to hold the object 6 as the result of the determination at step S16 or S18, and in addition, the solenoid 57 is driven so that the contact portion 56f applies a pressing force to the object 6. Accordingly, the object 6 is reliable held by the adhesion of the adhesive layer 10a of the holding sheet 10 and the pressing force of the contact portion 56f so as not to be moved relative to the holding sheet 10. Furthermore, the pressing member 56 is moved relative to the object 6 during the cutting. However, since the contact portion 56f is made of the material with a low friction coefficient, a frictional force produced between the contact portion 56f and the object 6 can be reduced as much as possible.

The user removes the object 6 from the holding sheet 10 upon end of the cutting of the object 6. In this case, the object 6 can easily be removed since the adhesion of the adhesive layer 10a of the holding sheet 10 is set according to the object 6 as described above.

In the cutting apparatus 1 of the embodiment described above, a plurality of types of holding sheets 10 is prepared according to the types of the objects 6 and are configured to hold the corresponding types of the objects 6 by means of adhesion. Furthermore, the control circuit 61 functions as the determination unit which determines whether or not the type of the object 6 based on user's input by operation of the operation switches 65 is consistent with the type of the holding sheet 10 detected by the optical sensor 66. The control circuit 61 executes the control according to the results of the determination.

According to the above-described control manner, the object 6 can be held on the holding sheet 10 according to the type of the object 6, whereupon the object 6 can be prevented from displacement on the holding sheet 10 during the cutting. Furthermore, when an erroneous type of holding sheet 10 is selected and set to the cutting apparatus 1 together with the object 6, the determining unit can determine whether or not the type of the holding sheet 10 is inconsistent with the type of the object 6 entered by the user. Consequently, although the plural types of holding sheets are used, the object 6 can accurately be cut since the control is executed according to the result of determination by the determining unit.

The control circuit 61 controls the LCD 9 to display the result of determination by the determining unit on the screen thereby to inform the determination result of the user. According to this configuration, the user can be informed as to whether or not the type of the holding sheet 10 is suitable for the object 6. Accordingly, when the type of the holding sheet 10 has erroneously been set, the user can re-set a correct type of holding sheet 10.

The adhesive layer 10a provided on the holding sheet 10 has an adhesion that is determined according to the type of the object 6 so that the object 6 is immovably held on the holding sheet 10 when cut by the cutter 4. Accordingly, the object 6 can reliably be prevented from displacement on the holding sheet 10, whereby the object 6 can accurately be cut.

The holding sheet 10 is set in the cutting apparatus 1 in the predetermined orientation or in a 180-degree opposite direction. The identification marks 60 are provided on the peripheral ends of the holding sheet 10 and at the respective positions such that the identification marks 60 can be detected by the optical sensor 66 even when the holding sheet 10 is set in the cutting apparatus 1 in either orientation. Accordingly, since there is no limit to the orientation in which the holding sheet 10 is set, the usability of the cutting apparatus can be improved. Furthermore, since the identification marks 60 are provided on the peripheral end of the holding sheet 10, the identification marks 60 do not stand in the way of affixing the object 6 to the holding sheet 10.

The detection unit is provided with the optical sensor which reads the information of the identification mark 60 in an optical manner. Accordingly, the identification medium can be detected reliably and easily by a simple configuration. Since the plural types of holding sheets 10 are affixed with the marks 59 or different colors, the user can easily determine the type of the holding sheet 10.

Part of the processing can be modified in the flowchart of FIG. 14 as follows. The type of the holding sheet 10 (types A to D) is entered at step S11, instead of the type of the object 6. At step S16, it is determined whether or not the type of the holding sheet 10 entered at step S11 is consistent with the type of the holding sheet 10 detected at step S11. In this case, too, even when the user has affixed the object 6 to an erroneous type of holding sheet 10, which has been set in the cutting apparatus 1, the determination unit can determine that the type of the set holding sheet 10 is inconsistent with the type of the holding sheet 10 entered by the user. Accordingly, although the cutting apparatus 1 is configured to use the plural types of holding sheets 10, the control is executed according to the result of determination by the determination unit, whereupon the object 6 can accurately be cut.

The above-described input unit may be configured to input either one or both of a type of the object 6 and a type of the holding sheet 10. In the latter case, even when both the type of the object 6 and the type of the holding sheet 10 are input, the determination unit which determines whether or not the type of the object input from the input unit and the type of the holding member detected by the detection unit are consistent with each other, the determination unit determines whether or not either one type and the type of the holding sheet 10 detected by the detection unit are consistent with each other. However, the determination unit may determine whether or not both of the type of the object 6 and the type of the holding sheet 10 and the type of the holding sheet 10 detected by detection unit are inconsistent with each other.

The foregoing embodiments described with reference to the accompanying drawings are not restrictive but may be modified or expanded as follows. The embodiment should not be limited to the cutting apparatus 1 as the cutting plotter. The embodiment may include various devices and apparatuses provided with respective cutting functions. Since the object 6 can immovably be held by the adhesion of the adhesive layer 10a of the holding sheet 10 in the embodiment, the pressing unit including the solenoid 57 may eliminated.

The above-described input unit should not be limited to the operation switches 65 and the LCD. The above-described touch panel may be used, and thus, any means that is capable of inputting the type of the object 6 or the type of the holding sheet 10 by the user may be used. A buzzer may be activated as the informing unit which informs the user of the result of determination by the determination unit, or a loud speaker may be provided to produced voice for the informing purpose.

The identification medium should not be limited to the identification mark 60. Any identification medium may be provided that is configured to be read by the detection unit for the purpose of specifying the type of the holding sheet 10. For example, concavo-convex portions or notches which differ according to types of the holding sheets 10 may be provided on the upper side of the holding sheet 10 as the identification medium.

The storage medium storing the control program should not be limited to the ROM 62 of the cutting apparatus 1. The storage medium may be a CD-ROM, flexible disc DVD, memory card or the like. In this case, when the control program stored in the storage medium is read into computers of various devices and apparatuses provided with respective cutting functions thereby to be executed, the same operation and the same advantageous effects as those described in the foregoing embodiments can also be achieved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus provided with a control unit which executes control to move a cutting blade and an object to be cut relative to each other thereby to cut the object by the cutting blade, the cutting apparatus comprising:
a holding member selectable from a plurality of types of holding members according to respective types of the objects, the holding member being provided with an adhesive layer which removably holds the object, the holding member being set on the cutting apparatus while holding the object corresponding thereto, which is adherent to the adhesive layer of the holding member;
an identification medium which is provided on the holding member for identifying a type of the holding member;
an input unit which is actuated for a user to input at least one of the type of the object and the type of the holding member into the control unit before the object is cut;
a detection unit which detects the type of the holding member from the identification medium when the holding member has been set to the cutting apparatus; and
a determination unit which determines whether or not the type of the object input from the input unit and the type of the holding member detected by the detection unit are consistent with each other and/or whether or not the type of the holding member detected by the detection unit and the type of the holding member input from the input unit are consistent with each other,
wherein the control unit is configured to perform the control according to a result of determination by the determination unit.

2. The apparatus according to claim 1, further comprising an informing unit, wherein the control unit controls the informing unit so that the result of determination by the determination unit is informed.

3. The apparatus according to claim 1, wherein the adhesive layer provided on the holding member has an adhesion according to the type of the object so that the object is immovably held by the holding member when the object is cut by the cutting blade.

4. The apparatus according to claim 1, wherein the holding member is set to the cutting apparatus in a predetermined direction or in a direction 180°-opposed to the predetermined direction relative to the cutting apparatus, and the identification medium is provided on a periphery of the holding member and the holding member id provided at such a position that the type of the holding member is detected by the detection unit when the holding member is set in either direction relative to the cutting apparatus.

5. The apparatus according to claim 1, wherein detection unit includes an optical sensor which optically reads information of the identification medium.

6. The apparatus according to claim 1, wherein a mark or a color is applied to the holding member so that the user is capable of determining the type of the holding member when viewing the holding member.

7. A storage medium which is computer-readable and stores a control program that is used for a cutting apparatus which includes:
a holding member selectable from a plurality of types of holding members according to respective types of the objects, the holding member being provided with an adhesive layer which removably holds the object, the holding member being set on the cutting apparatus while holding the object corresponding thereto, which is adherent to the adhesive layer of the holding member;
a control unit which executes control to move a cutting blade and an object to be cut relative to each other thereby to cut the object by the cutting blade;
an identification medium which is provided on the holding member for identifying a type of the holding member; and
an input unit which is actuated for a user to input at least one of the type of the object and the type of the holding member into the control unit before the object is cut, the control program comprising:
a detection routine of detecting the type of the holding member from the identification medium when the holding member has been set to the cutting apparatus;
a determination routine of determining whether or not the type of the object input from the input unit and the type of the holding member detected by the detection unit are consistent with each other and/or whether or not the type of the holding member detected by the detection unit and the type of the holding member input from the input unit are consistent with each other; and
a control routine of executing control by the control unit according to a result of determination in the determination routine.

8. The storage medium according to claim 7, wherein the cutting apparatus further includes an informing unit, and the control unit controls the informing unit so that the result of determination by the determination unit is informed.
